(19) United States
(12) Patent Application Publication
(10) Pub. No.: US 2026/0011864 A1
(43) Pub. Date: Jan. 8, 2026

(54) BATTERY MODULE AND BATTERY PACK

(71) Applicant: SK On Co., Ltd., Seoul (KR)

(72) Inventors: Su A KIM, Daejeon (KR); Yu Bin KANG, Daejeon (KR); Jin Woo SON, Daejeon (KR)

(21) Appl. No.: 19/251,804

(22) Filed: Jun. 27, 2025

(30) Foreign Application Priority Data
Jul. 3, 2024 (KR) 10-2024-0087683

(51) Int. Cl. H01M 50/383; H01M 10/647; H01M 10/658; H01M 50/211; H01M 50/258; H01M 50/271; H01M 50/293; H01M 50/30

(52) U.S. Cl. CPC H01M 50/383; H01M 10/647; H01M 10/658; H01M 50/211; H01M 50/258; H01M 50/271; H01M 50/293; H01M 50/394

(57) ABSTRACT

According to the present disclosure, provided is a battery module including: a plurality of battery units respectively including a plurality of battery cells; a module housing accommodating the plurality of battery units; an upper cover covering an upper portion of the module housing and including at least one vent hole; and a barrier disposed between the plurality of battery units to prevent thermal propagation, the barrier including: a first barrier disposed between the plurality of battery units; and a second barrier extending from the first barrier in a first direction, a stacking direction of the plurality of battery cells.

### CROSS-REFERENCE TO RELATED APPLICATION(S)

This patent document claims the priority and benefits of Korean Patent Application No. 10-2024-0087683 filed on Jul. 3, 2024, the disclosure of which is incorporated herein by reference in its entirety.

### TECHNICAL FIELD

The present disclosure relates to a battery module and a battery pack.

### BACKGROUND

Secondary batteries are one type of energy storage device that may be charged with and discharged of electricity. Secondary batteries are widely used in various devices that use electricity as a power source. For example, secondary batteries are used as energy storage devices in various means ranging from small devices such as mobile phones, laptop computers, and tablets to large devices such as vehicles and aircraft. Specifically, secondary batteries have been actively sought for use as a vehicle power source recently.

Secondary batteries may be classified into lead-acid batteries, nickel-cadmium batteries, nickel-hydrogen batteries, and lithium-ion batteries depending on the material of the electrode. Secondary batteries of each type may be appropriately selected according to design capacity, usage environment, and the like. Alternatively, secondary batteries may be all-solid-state batteries that use solid electrolytes instead of liquid electrolytes. Lithium-ion batteries may implement relatively high voltage and capacity compared to other types of secondary batteries. Accordingly, lithium-ion batteries are widely used in fields that require high-density energy storage devices such as vehicle battery packs.

Secondary batteries such as lithium-ion batteries may include a cathode, an anode, a separator, and an electrolyte. The cathode and the anode are disposed with an insulating separator interposed therebetween, and charging or discharging may be performed by the movement of ions through the electrolyte.

Secondary batteries are manufactured as flexible pouch-type battery cells or rigid square or cylindrical can-type battery cells.

Cell assemblies may be disposed inside a module housing to form a battery module, and a plurality of battery modules may be disposed inside a pack housing to form a battery pack.

In addition, recently, a Cell to Pack (CTP) method is used in which the formation of a battery module is omitted, and battery cells are directly integrated into a battery pack and the battery pack is connected to a main body frame.

### SUMMARY

According to an aspect of the present disclosure, high-temperature gas or flames inside a battery module may be guided to a vent hole and then discharged.

According to an aspect of the present disclosure, high-temperature gas or flames may be prevented from spreading to an adjacent battery unit.

A battery module and a battery pack of the present disclosure may be widely applied to electric vehicles, battery charging stations, and devices in green technology fields such as solar power generation and wind power generation using other batteries. In addition, the battery module and the battery pack of the present disclosure may be used in eco-friendly electric vehicles, hybrid vehicles, and the like, for ameliorating the effects of climate change by suppressing air pollution and greenhouse gas emissions.

A battery module according to the present disclosure may include: a plurality of battery units respectively including a plurality of battery cells; a module housing accommodating the plurality of battery units; an upper cover covering an upper portion of the module housing and including at least one vent hole; and a barrier disposed between the plurality of battery units to prevent thermal propagation, and the barrier may include: a first barrier disposed between the plurality of battery units; and a second barrier connected to the first barrier and extending in a first direction, the first direction being a stacking direction of the plurality of battery cells. In an embodiment, the at least one vent hole may be disposed in an upper portion of each battery unit.

In an embodiment, the first barrier may be disposed in a lower portion of a first region, and the first region may be a region disposed between the at least one vent hole and another adjacent vent hole.

In an embodiment, the second barrier may extend from an upper portion of the first barrier in the first direction.

In an embodiment, the second barrier may be disposed so as not to overlap the at least one vent hole in a second direction that is a vertical direction of the upper cover.

In an embodiment, the second barrier may extend from an end of the first barrier to both sides in the first direction.

In an embodiment, an upper surface of the second barrier may include a flat surface.

In another embodiment, an upper surface of the second barrier may include a curved surface.

In another embodiment, both ends of the second barrier may extend in a direction oriented toward the at least one vent hole, respectively.

In another embodiment, the second barrier may extend from an end of the first barrier to one side in the first direction.

In another embodiment, an upper surface of the second barrier may include a curved surface.

In another embodiment, one end of the second barrier may extend in a direction oriented toward the at least one vent hole.

In another embodiment, the first barrier may be disposed to face a side surface of the battery cell.

A battery pack according to the present disclosure may include: a plurality of battery modules; and a pack frame accommodating the plurality of battery modules, and at least one of the plurality of battery modules may include: a plurality of battery units respectively including a plurality of battery cells; a module housing accommodating the plurality of battery units; an upper cover covering an upper portion of the module housing and including at least one vent hole; and a barrier disposed between the plurality of battery units to prevent thermal propagation, and the barrier may include: a first barrier disposed between the plurality of battery units; and a second barrier connected to the first barrier and extending in a first direction, the first direction being a stacking direction of the plurality of battery cells.

In an embodiment, the at least one vent hole may be disposed in an upper portion of each battery unit.

In an embodiment, the second barrier may extend from an upper portion of the first barrier to both sides in the first direction or to one side in the first direction.

In an embodiment, the second barrier may be disposed so as not to overlap the at least one vent hole in the second direction that is a vertical direction of the upper cover.

According to an aspect of the present disclosure, high-temperature gas or flames inside a battery module may be guided to a vent hole and then discharged.

According to an aspect of the present disclosure, high-temperature gas or flames may be prevented from passing to an adjacent battery unit.

### BRIEF DESCRIPTION OF DRAWINGS

Certain aspects, features, and advantages of the present disclosure are illustrated by the following detailed description with reference to the accompanying drawings.

FIG. 1 is an exploded perspective view illustrating a battery module based on the present disclosure.

FIG. 2 is an enlarged perspective view of A in FIG. 1.

FIG. 3 is a cross-sectional view taken along line I-I′ in FIG. 1.

FIG. 4 is a cross-sectional view illustrating another embodiment.

FIG. 5 is a cross-sectional view illustrating another embodiment.

FIG. 6 is a cross-sectional view illustrating another embodiment.

FIG. 7 is a cross-sectional view illustrating a battery pack based on the present disclosure.

### DETAILED DESCRIPTION

Hereinafter, embodiments of the present disclosure will be described with reference to the attached drawings. For convenience, in the following description, detailed descriptions of components that may obscure the technical gist of the present disclosure or well-known components will be omitted.

A secondary battery or a battery cell described in this specification may encompass a rechargeable battery. For example, the secondary battery may include a lead-acid battery, a nickel-cadmium battery, a nickel-hydrogen battery, and a lithium-ion battery. This description mainly assumes that the secondary battery is a lithium-ion battery. However, it should be understood that the technical concepts described in this specification may be applied to other suitable types of batteries in addition to lithium-ion batteries.

Hereinafter, it should be noted that in the attached drawings, identical components are indicated by identical symbols whenever possible. Some components are exaggerated, omitted, or schematically depicted in the accompanying drawings, and the size of each component does not entirely reflect its actual size.

Meanwhile, if a thermal runaway or thermal propagation situation occurs in a battery module, high-temperature gas or fire may occur inside the module. The gas or fire may need to be properly discharged to the outside of the module. In this case, the gas or fire may occur in a localized area of the module, and it may be necessary to prevent the gas or fire from spreading to other battery cells in the module or to adjacent modules through proper discharge.

Hereinafter, a battery module and a battery pack according to the present disclosure will be specifically described with reference to the drawings.

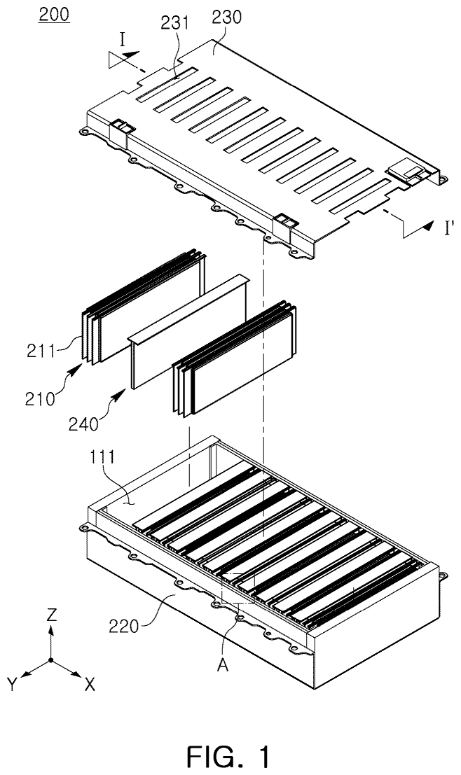

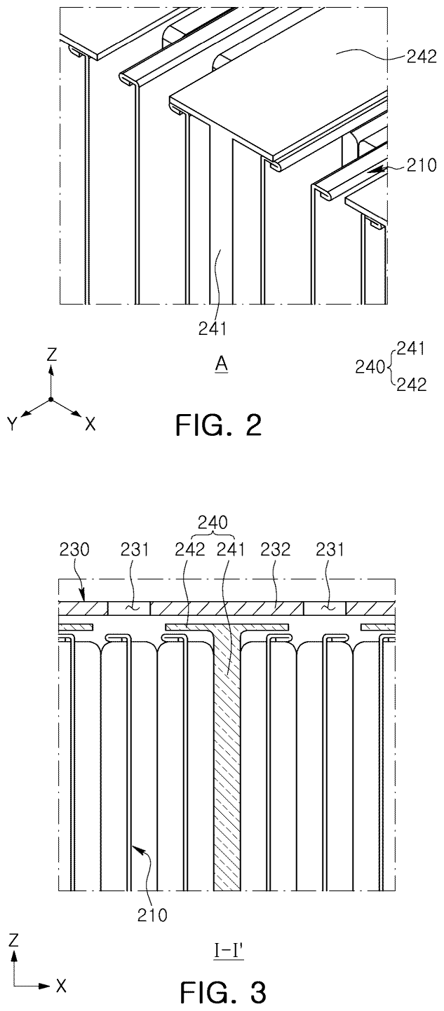

FIG. 1 is an exploded perspective view illustrating a battery module 200 according to the present disclosure, FIG. 2 is an enlarged perspective view of A in FIG. 1, and FIG. 3 is a cross-sectional view taken along line I-I′ in FIG. 1.

FIGS. 2 and 3 illustrate only a portion of the battery module 200.

Referring to FIGS. 1 to 3, the battery module 200 according to the present disclosure may include a plurality of battery units 210, a module housing 220, an upper cover 230, and a barrier 240.

Each of the plurality of battery units 210 may include a plurality of battery cells 211. In other words, the battery unit 210 may be an assembly including the plurality of battery cells 211. In this case, the battery cells 211 may be arranged in a certain direction (X-direction) and may be in a stacked state. Hereinafter, a stacking direction of the battery cell 211 is defined as the first direction (X-direction). Each battery cell 211 may output or store electrical energy.

The battery cell 211 may be formed of a lithium secondary battery, but is not limited thereto. For example, the battery cell 211 may be formed of various types of secondary batteries such as a nickel-cadmium battery, a nickel-metal hydride battery, and a nickel-hydrogen battery. The battery cell 211 may be formed of a pouch-type secondary battery. Hereinafter, a case in which a pouch-type secondary battery is used as the battery cell 211 will be described as an example. However, the present disclosure does not exclude the use of a can-type secondary battery such as a square secondary battery or a cylindrical secondary battery as the battery cell 211.

The module housing 220 may accommodate the battery unit 210. For example, the module housing 220 may include an accommodation space 221 to accommodate the battery unit 210. In order to form the accommodation space 221, the module housing 220 may include a lower plate and a side plate. The lower plate and the side plate may be combined with each other to form an accommodation space 221 inside. A shape of the module housing 220 or the accommodation space 221 may be various. For example, each shape may include a rectangular parallelepiped. A plurality of battery units 210 may be arranged in the accommodation space 221 in a first direction (X-direction) that is the same direction as a direction in which the battery cells 211 are arranged.

The upper cover 230 may cover an upper portion of the module housing 220. The upper cover 230 may include a plate shape and may include an area sufficiently large to cover at least the accommodation space 221. After a plurality of battery units 210 are accommodated in the accommodation space 221, the upper cover 230 may cover an upper portion thereof.

The upper cover 230 may include at least one vent hole 231. The vent hole 231 may be a hole for discharging high-temperature gas or flames generated inside the module housing 220 or foreign substances generated therefrom. The vent hole 231 may be a hole formed by perforating at least a portion of the upper cover 230. The shape of the vent hole 231 may be variable. For example, the vent hole 231 may include an oval shape. In addition, the vent holes 231 may be disposed in several rows in the first direction (X-direction) of the battery cells 211. A size of the vent hole 231 may be variable. The vent hole 231 may be disposed in an upper portion of the battery unit 210 or the accommodation space 221, so that high-temperature gas or flames may rise and may be discharged to the outside of the battery module 200 through the vent hole 231.

At least one vent hole 231 may be disposed in the upper portion of each battery unit 210. For example, when there are four battery units 210 accommodated in the module housing 220, the upper cover 230 may include at least four vent holes 231 so that at least one vent hole 231 is matched to each battery unit 210. That is, when a fire occurs in each battery unit 210, high-temperature gas or flames may be discharged to the outside of the battery module 200 through the vent hole 231 matched to each battery unit 210.

The barrier 240 may be configured to be disposed between a plurality of battery units 210 to prevent the propagation of flames. For example, the barrier 240 may be formed of a material having fire resistance or heat resistance. The barrier 240 may include a metallic material such as steel, aluminum, or nickel. Accordingly, even if high-temperature gas or flames are generated, the high-temperature gas or flames may not pass through the barrier 240.

The barrier 240 may include a first barrier 241 and a second barrier 242.

The first barrier 241 may be disposed between a plurality of battery units 210. That is, the first barrier 241 may be disposed between a battery unit 210 and another adjacent battery unit 210. The accommodation space 221 may be separated by the first barrier 241. For example, the first barrier 241 may include a plate shape. The first barrier 241 may be arranged in parallel with the plurality of battery cells 211. For example, the first barrier 241 may be disposed to face a side surface of the battery cell 211. Accordingly, the first barrier 241 may block high-temperature gas or flames generated by one battery unit 210 from spreading to another adjacent battery unit 210.

More specifically, the first barrier 241 may be disposed in a lower portion of a first region 232. In this case, the first region 232 may be a region disposed between at least one vent hole 231 and another adjacent vent hole 231. In this case, another adjacent vent hole 231 may be a vent hole 231 adjacent in the first direction (X-direction). The first barrier 241 may not overlap the vent hole 231 in a second direction (Z-direction) that is a vertical direction of the upper cover 230. In other words, the first barrier 241 may be disposed so as not to cover the vent hole 231. Accordingly, it may be possible to prevent high-temperature gas or flames from spreading to the adjacent battery unit 210 through the same vent hole 231.

The second barrier 242 may be configured to extend from the first barrier 241 in the first direction (X-direction). In this case, the meaning of extending in the first direction (X-direction) may include a case of extending at a predetermined angle with the first direction (X-direction). In other words, the meaning thereof also includes a case of extending in the second direction (Z-direction) that is a vertical direction of the upper cover 230, while extending in the first direction (X-direction).

Specifically, the second barrier 242 may extend in the first direction (X-direction) from the upper portion of the first barrier 241. For example, when the first barrier 241 is erected in the second direction (Z-direction), the second barrier 242 may be configured to extend in the first direction (X-direction) from an upper portion of the first barrier 241. That is, the first barrier 241 and the second barrier 242 may be perpendicular to each other. However, the first barrier 241 and the second barrier 242 are only one example of an extending form of the second barrier 242, and are not necessarily perpendicular to each other.

In this case, the second barrier 242 may be disposed so as not to overlap at least one vent hole 231 in the second direction (Z-direction). That is, the second barrier 242 may extend so as not to cover the vent hole 231. A range in which the second barrier 242 extends may be appropriately adjusted within a range that does not block the vent hole 231. That is, high-temperature gas or flames may move along the second barrier 242 and may be naturally guided to the vent hole 231.

The second barrier 242 may extend from an end of the first barrier 241 to both sides in the first direction (X-direction). Referring to FIG. 3, the second barrier 242 may be extended from the end of the first barrier 241. When viewed from a side surface, the second barrier 242 may be extended to both sides based on the first barrier 241. In this case, an upper surface of the second barrier 242 may include a flat surface. In other words, when viewed from the side surface, the first barrier 241 and the second barrier 242 may include a ‘T’ shape. However, this is only one example of the various possible shapes of the second barrier 242 and is not necessarily limited thereto. The second barrier 242 may extend toward the vent holes 231 disposed on both sides of the first barrier 241. In this case, the second barrier 242 may guide the high-temperature gas or flames generated by the battery units 210 disposed on both sides to the vent holes 231 disposed above each battery unit 210.

The high-temperature gas or flames generated by the battery unit 210 rises due to the high temperature. In this case, the high-temperature gas or flames may not pass to another adjacent battery unit 210 due to the first barrier 241. In the process in which the high-temperature gas or flames rises, the high-temperature gas or flames may move in the first direction (X-direction) along the second barrier 242 and may be discharged through the vent holes 231.

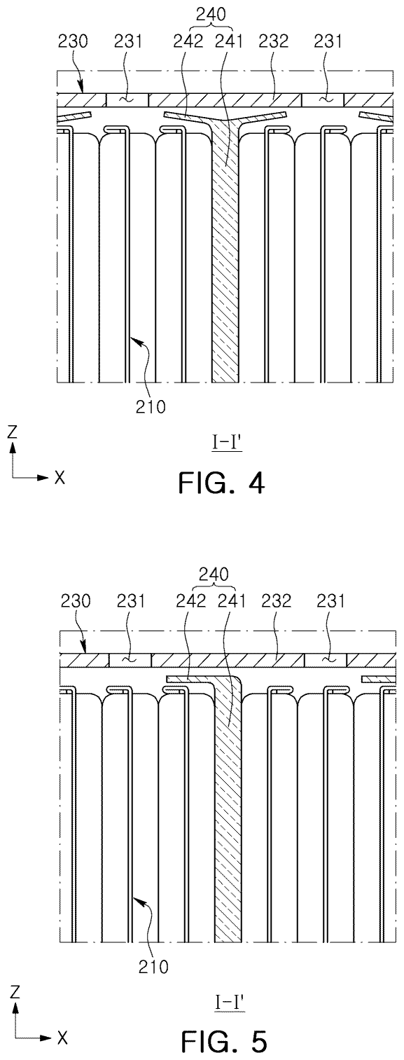

FIG. 4 is a cross-sectional view illustrating another embodiment.

Referring to FIG. 4, an upper surface of the second barrier 242 may include a curved surface. A certain space may be formed between the second barrier 242 and the upper cover 230. That is, the second barrier 242 and the upper cover 230 may be spaced apart from each other. In this case, the second barrier 242 may be bent to include a curved surface so that an end of the second barrier 242 may be formed to get close to the vent hole 231.

For example, both ends of the second barrier 242 may extend in a direction oriented toward at least one vent hole 231. In other words, the second barrier 242 may extend upwardly toward both ends. High-temperature gas or flames may be guided to the vent hole 231 along the second barrier 242.

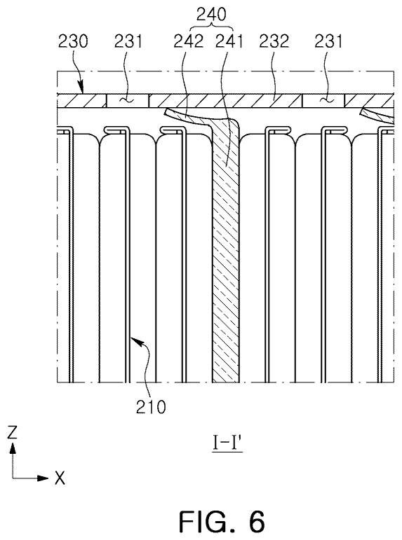

FIGS. 5 and 6 are cross-sectional views illustrating different embodiments, respectively.

Referring to FIGS. 5 and 6, the second barrier 242 may extend from the end of the first barrier 241 to one side in the first direction (X-direction). As compared to the second barrier 242 of FIGS. 3 and 4, the second barrier 242 may not extend to both sides of the first barrier 241, but may extend only to one side thereof. An extension direction may be appropriately changed. For example, the extension direction of the second barrier 242 may be selected by selecting which vent hole 231 to be guided among the vent holes 231 disposed on both sides.

In this case, the second barrier 242 may be formed to include a flat surface or a curved surface.

For example, referring to FIG. 5, an upper surface of the second barrier 242 may include a flat surface. Accordingly, the first barrier 241 and the second barrier 242 may include an ‘L’ shape when viewed from the side surface.

In contrast, referring to FIG. 6, an upper surface of the second barrier 242 may include a curved surface. In this case, one end of the second barrier 242 may extend in a direction oriented toward at least one vent hole 231. That is, the second barrier 242 may extend to include a curved surface while rising toward the vent hole 231 on one side.

A shape of the second barrier 242 may include various shapes in addition to the shapes presented in FIGS. 1 to 6. Accordingly, the shape of the second barrier 242 described above is merely an example and may be appropriately changed within the scope of achieving the purpose of the present disclosure.

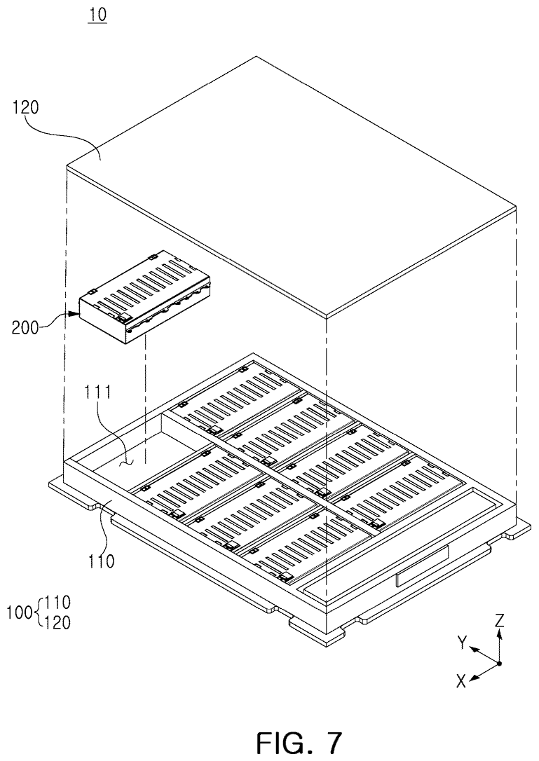

FIG. 7 is a cross-sectional view illustrating a battery pack 10 according to the present disclosure. Referring to FIG. 7, the battery pack 10 according to the present disclosure may include a plurality of battery modules 200 and a pack frame 100.

The plurality of battery modules 200 may be an assembly formed by collecting a plurality of battery modules 200.

At least one of the plurality of battery modules 200 included in the battery pack 10 may be any one of the battery modules 200 described in FIGS. 1 to 6.

The pack frame 100 may accommodate a plurality of battery modules 200. For example, the pack frame 100 may include a pack lower frame 110 and a pack cover 120.

The pack lower frame 110 may be disposed in a lower portion of the battery pack 10 and may include a plurality of module accommodation spaces 111. The plurality of module accommodation spaces 111 may be partitioned by a partition wall. The battery modules 200 may be accommodated in each module accommodation space 111.

The pack cover 120 may cover the pack lower frame 110. In other words, the pack cover 120 may cover a plurality of battery modules 200 accommodated in the pack lower frame 110.

Although the embodiments of the present disclosure have been described in detail above, the scope of the present disclosure is not limited thereto, and it will be obvious to those skilled in the art that various modifications and variations are possible within a scope that does not depart from the technical concept of the present disclosure described in the claims.

In addition, the present disclosure may be implemented by deleting or changing some of the components in the above-described embodiments, and respective embodiments may be implemented in combination with each other.

What is claimed is:

1. A battery module, comprising:
a plurality of battery units respectively including a plurality of battery cells;
a module housing accommodating the plurality of battery units;
an upper cover covering an upper portion of the module housing and including at least one vent hole; and
a barrier disposed between the plurality of battery units to prevent thermal propagation,
wherein the barrier includes:
a first barrier disposed between the plurality of battery units; and
a second barrier connected to the first barrier and extending in a first direction, the first direction being a stacking direction of the plurality of battery cells.

2. The battery module of claim 1, wherein the at least one vent hole is disposed in an upper portion of each battery unit.

3. The battery module of claim 2, wherein the first barrier is disposed in a lower portion of a first region, and
the first region is a region disposed between the at least one vent hole and another adjacent vent hole.

4. The battery module of claim 1, wherein the second barrier extends from an upper portion of the first barrier in the first direction.

5. The battery module of claim 1, wherein the second barrier is disposed so as not to overlap the at least one vent hole in a second direction that is a vertical direction of the upper cover.

6. The battery module of claim 1, wherein the second barrier extends from an end of the first barrier to both sides in the first direction.

7. The battery module of claim 6, wherein an upper surface of the second barrier includes a flat surface.

8. The battery module of claim 6, wherein an upper surface of the second barrier includes a curved surface.

9. The battery module of claim 8, wherein both ends of the second barrier extend in a direction oriented toward the at least one vent hole, respectively.

10. The battery module of claim 1, wherein the second barrier extends from an end of the first barrier to one side in the first direction.

11. The battery module of claim 10, wherein an upper surface of the second barrier includes a curved surface.

12. The battery module of claim 11, wherein one end of the second barrier extends in a direction oriented toward the at least one vent hole.

13. The battery module of claim 1, wherein the first barrier is disposed to face a side surface of the battery cell.

14. A battery pack, comprising:
a plurality of battery modules; and
a pack frame accommodating the plurality of battery modules,
wherein at least one of the plurality of battery modules includes:
a plurality of battery units respectively including a plurality of battery cells;
a module housing accommodating the plurality of battery units;
an upper cover covering an upper portion of the module housing and including at least one vent hole; and
a barrier disposed between the plurality of battery units to prevent thermal propagation,
wherein the barrier includes:
a first barrier disposed between the plurality of battery units; and
a second barrier connected to the first barrier and extending in a first direction, the first direction being a stacking direction of the plurality of battery cells.

15. The battery pack of claim 14, wherein the at least one vent hole is disposed in an upper portion of each battery unit.

16. The battery pack of claim 14, wherein the second barrier extends from an upper portion of the first barrier to both sides in the first direction or to one side in the first direction.

17. The battery pack of claim 14, wherein the second barrier is disposed so as not to overlap the at least one vent hole in the second direction that is a vertical direction of the upper cover.
